(19) United States
(12) Patent Application Publication
(10) Pub. No.: US 2010/0271301 A1
(43) Pub. Date: Oct. 28, 2010

(54) INPUT PROCESSING DEVICE

(75) Inventors: Kazuhito OHSHITA, Fukushima-ken (JP); Kenji Watanabe, Fukushima-ken (JP); Toshio Kawano, Fukushima-ken (JP); Yoshiyuki Kikuchi, Fukushima-ken (JP); Shigetoshi Amano, Fukushima-ken (JP); Koichi Miura, Fukushima-ken (JP); Sadakazu Shiga, Fukushima-ken (JP); Shoji Suzuki, Fukushima-ken (JP)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: ALPS ELECTRIC CO., LTD., Tokyo (JP)

(21) Appl. No.: 12/767,242

(22) Filed: Apr. 26, 2010

(30) Foreign Application Priority Data
Apr. 27, 2009 (JP) 2009-108197

(51) Int. Cl. G06F 3/033

(52) U.S. Cl. 345/158

(57) ABSTRACT

An input processing device includes an input pad; a detector which detects a position of an indicating object coming into contact with the input pad; and a processor which controls a display state of an image displayed on a display on the basis of an input signal obtained from the detector, wherein an input surface of the input pad is provided with a detection region for detecting a specific input operation, and wherein when the processor receives the input signal corresponding to the specific input operation given from the indicating object onto the detection region, the processor rotates the image.

### CROSS REFERENCE TO RELATED APPLICATIONS

The present invention contains subject matter related to and claims the benefit of Japanese Patent Application JP 2009-108197 filed in the Japanese Patent Office on Apr. 27, 2009, the entire contents of which is incorporated herein by reference.

### BACKGROUND OF THE DISCLOSURE

1. Technical Field

The present invention relates to an input processing device which performs a process of rotating the display contents displayed on a display when a planar input pad is operated by an indicating object.

2. Related Art

A keyboard or a mouse can be used as an input processing device mounted to a personal computer. In a notebook-type personal computer, a planar input member having an input pad is mounted in addition to the keyboard. The planar input member is configured to detect a variation in capacitance between electrodes when a low-potential indicating object such as a human finger approaches or comes into contact with the input pad. Since it is possible to obtain coordinate data on the basis of a variation in capacitance, a controller of the personal computer generates a control signal which is the same as a control signal generated upon operating the mouse as an external device on the basis of the coordinate data which can be obtained from the input member.

In recent years, a personal computer has been introduced which is capable of rotating an image displayed on a display by operating a tablet-type input device provided in an overlapping manner on a display screen using a pen or a finger.

For example, JP-A-2007-011035 discloses an image display method of a computer which displays an image displayed on a display so as to be rotated by one of 90°, 180°, and 270°.

The image display method of the computer disclosed in JP-A-2007-011035 has a configuration in which the image is rotated when a rotation selection switch connected to a bus controller is operated by an operator. The rotation selection switch has a configuration in which an exclusive key is provided in a keyboard or a general key of the keyboard is provided so as to have an allocated function.

However, in the method of providing the exclusive key in the keyboard, there is a problem in that the number of components increases. Further, there is a problem involved with a space when a region other than the general keys is ensured on the keyboard.

In addition, in the method of allocating the rotation function to the general key, since it is necessary to simultaneously operate a plurality of keys by using a plurality of fingers, there are problems in that the operation is complex and it is easy to forget the arrangement of the keys.

Further, there is a method of rotating an image by clicking an exclusive rotation icon provided in a task bar displayed on a display. However, there are problems in that it is complex to move a cursor onto the icon and it is not possible to continuously rotate the image due to the clicking performed by the unit of 90°.

These and other drawbacks exist.

### SUMMARY OF THE DISCLOSURE

An advantage of various embodiments is to provide an input processing device capable of rotating an image displayed on a display of a computer by an arbitrary angle or continuously rotating the image just by performing a simple operation on an input pad.

According to an exemplary embodiment, an input processing device includes: an input pad; a detector which detects a position of an indicating object coming into contact with the input pad; and a processor which controls a display state of an image displayed on a display on the basis of an input signal obtained from the detector, wherein an input surface of the input pad is provided with a detection region for detecting a specific input operation, and wherein when the processor receives the input signal corresponding to the specific input operation given from the indicating object onto the detection region, the processor rotates the image.

In an input processing device according to various embodiments, it is possible to rotate an image by an arbitrary angle or to continuously rotate the image just by performing a simple operation on a detection region provided on the input pad using an indicating object (finger).

For example, when the specific input operation is a tap operation, the image is rotated upon performing the tap operation.

In addition, when the specific input operation is a push operation having a contact time longer than that of a tap operation, the image is continuously rotated during the push operation.

Likewise, in the input processing device according to various embodiment, it is possible to rotate the image just by a simple operation.

Also, the detection region may be allocated to any position of the input surface.

With the above-described configuration, it is possible to dispose the detection region at an easily noticed position.

The detection region is provided at two corners of the input surface so that the image is rotated right when the corner at one position is operated, and the image is rotated left when the corner at the other position is operated.

With the above-described configuration, it is possible to easily select the rotation direction of the image.

In addition, the specific input operation includes a first operation and a second operation performed after the first operation. In this case, the first operation may be detected in a first detection region, and the second operation may be detected in a detection region different from the first detection region.

With the above-described configuration, since the image is not rotated just by performing the first operation, it is possible to prevent such a problem that the indicating object carelessly comes into contact with the input pad to thereby rotate the image. In addition, since it is possible to clearly distinguish the first operation and the second operation, it is possible to prevent an unnecessary rotation due to other erroneous operations.

In the input processing device according to various embodiments, when the first operation is performed, the indicator showing instructions of the second operation is displayed.

With the above-described configuration, since it is possible to give instructions to the operator, it is possible even for a clumsy operator to reliably rotate the image.

Further, a detection region for detecting the second operation may include second and third detection regions extending in directions intersecting each other so that the image is rotated right when the second operation is performed on the second detection region, and the image is rotated left when the second operation is performed on the third detection region.

With the above-described configuration, it is possible to simply rotate the image just by sliding the indicating object on the second detection region or the third detection region. In addition, it is possible to freely select the rotation direction.

Also, the second operation may be a rotation operation drawn in a circular shape by the indicating object around the first operation.

With the above-described configuration, since it is possible to rotate the image just by a simple operation of drawing a circle on the input surface, it is possible to perform an intuitive operation.

In the input processing device according to various embodiments, the first operation is a tap operation, and the second operation is a slide operation or a push operation.

Further, the specific input operation is a rotation perpendicular movement operation of moving the indicating object in the perpendicular direction in the vicinity of the corner of the input surface.

With the above-described configuration, it is possible to rotate the image just by a simple operation.

In the input processing device according to the aspect of the invention, the processor may be operated by a software stored in a controller of a personal computer.

In addition, the processor may be operated by a driver for giving coordinate information to an operating system inside a controller on the basis of the input signal from the detector.

In the input processing device according to various embodiments, it is possible to rotate the image just by a simple operation using the input pad.

The driver software may change a setting of a rotation angle of the image.

With the above-described configuration, it is possible to rotate the image by the unit of the rotation angle desired by the operator or to continuously rotate the image.

In the input processing device according to various embodiments, it is possible to rotate the image displayed on the display by an arbitrary angle or to continuously rotate the image just by a simple operation using the touch pad.

Further, the special keys for operating rotation can become unnecessary.

### BRIEF DESCRIPTION OF THE DRAWINGS

FIG. 1 is a perspective view showing a notebook-type personal computer (PC) equipped with an input processing device according to an embodiment of the disclosure.

FIG. 2 is a plan view of a planar input member (touch pad).

FIG. 3 is a circuit block diagram of the input processing device.

FIG. 4 is a plan view of an input pad showing an embodiment of the disclosure.

FIG. 5 is a flowchart showing an example of an operation process by a driver software according to an embodiment of the disclosure.

FIG. 6 is a conceptual diagram showing an example of a rotating image.

FIG. 7 is a plan view of an input pad showing an embodiment of the disclosure and a diagram showing an example of an indicator displayed on a display.

FIG. 8 is a flowchart showing an example of the operation process by the driver software according to an embodiment of the disclosure.

FIG. 9 is a plan view of the input pad showing a third embodiment of the invention and a diagram showing a relationship with a rotating image.

FIG. 10 is a flowchart showing an example of the operation process by the driver software according to an embodiment of the disclosure.

FIG. 11 is a plan view of the input pad showing an embodiment of the disclosure.

FIG. 12 is a flowchart showing an example of an operation process by the driver soft according to an embodiment of the disclosure.

### DESCRIPTION OF EXEMPLARY EMBODIMENTS

The following description is intended to convey a thorough understanding of the embodiments described by providing a number of specific embodiments and details involving input processing devices. It should be appreciated, however, that the present invention is not limited to these specific embodiments and details, which are exemplary only. It is further understood that one possessing ordinary skill in the art, in light of known systems and methods, would appreciate the use of the invention for its intended purposes and benefits in any number of alternative embodiments, depending on specific design and other needs.

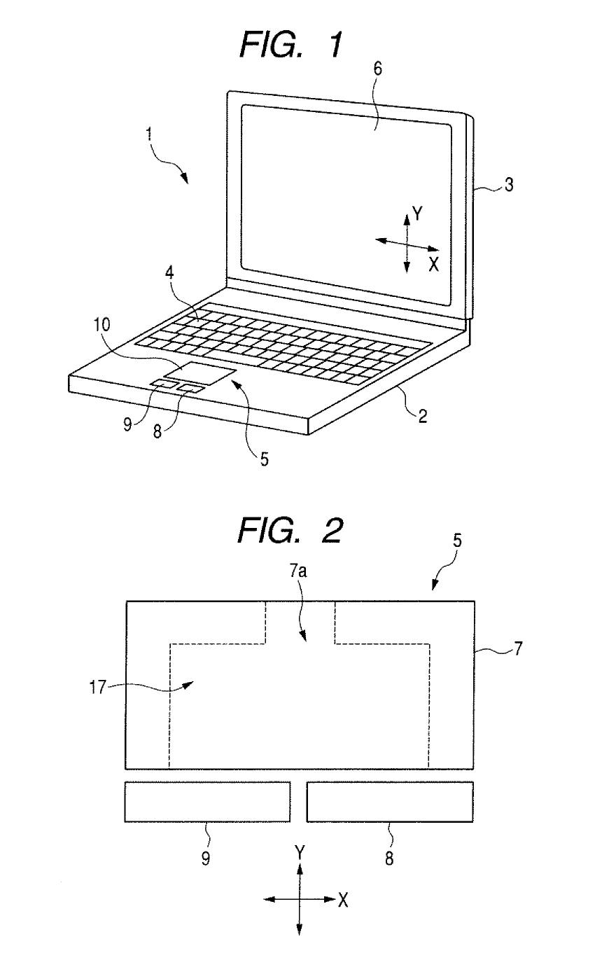

FIG. 1 is a perspective view showing a notebook-type personal computer (PC) equipped with an exemplary input processing device, and FIG. 2 is a plan view of a planar input member (touch pad).

A personal computer 1 shown in FIG. 1 may have a configuration in which a cover portion 3 may be foldably connected to a body 2. A keyboard 4 and a planar input member 5 may be provided in an operation panel of a surface of the body 2. A display 6 which may be formed by a liquid crystal display panel may be provided in a front surface of the cover portion 3.

As shown in the enlarged view of FIG. 2, the planar input member 5 may include an input pad (touch pad) 7, a right button 8 which may be located on the right and below the input pad, a left button 9 which may be located on the left and below the input pad, and the like.

The input pad 7 may include an input surface 7a which may be formed by a planar surface. In the input pad 7, a plurality of X electrodes extending in the X direction may face a plurality of Y electrodes extending in the Y direction with an insulating layer interposed therebetween, and a detection electrode may be provided between adjacent X electrodes. A thin insulating sheet may be provided on a surface of the electrode so that the surface of the insulating sheet may be used as the input surface 7a.

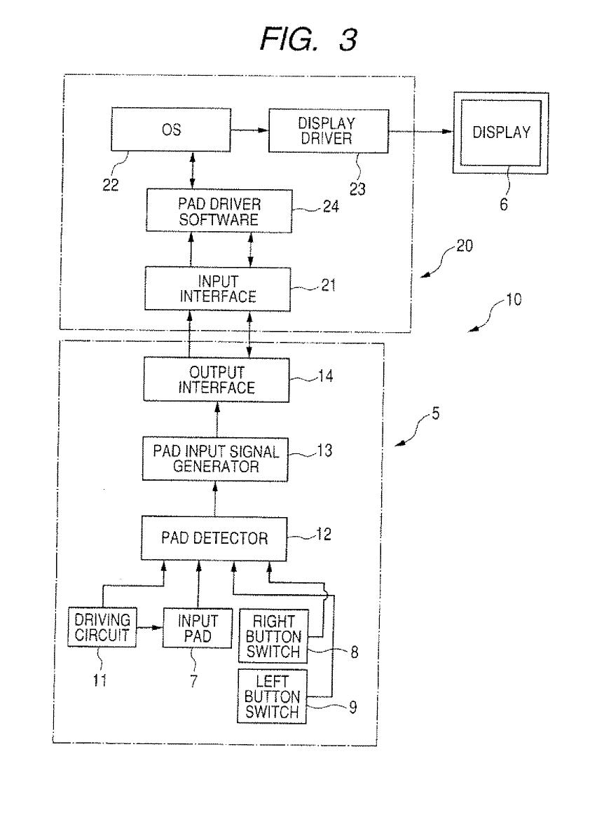

As shown in FIG. 3, a driving circuit 11 provided in the input member 5 sequentially may apply a predetermined voltage to the X electrodes, and may apply a predetermined voltage to the Y electrodes at a timing different from the timing for the X electrodes. When a finger as an indicating object of a conduction body having a substantially ground potential comes into contact with the input surface 7a, a capacitance may be formed between the finger and each electrode. Accordingly, at the portion contacting with the finger, the capacitance between the detection electrode and the X electrode may change, and the capacitance between the detection electrode and the Y electrode may change.

Due to a variation in the capacitance, a rising time of a pulsar voltage applied to the X electrode or the Y electrode may be delayed. At this time, the delay of the rising time may be detected by a pad detector 12 through the detection electrode. When the pad detector 12 detects the delay of the rising time of the voltage through the detection electrode, the position contacting with the finger maybe detected on the X-Y coordinate by obtaining timing information on the voltage applied to the X electrode and the Y electrode.

Accordingly, when the finger contacting with the input surface 7a moves, it may be possible to detect the movement locus of the finger on the X-Y coordinate. In addition, when a so-called tap operation is performed such that the finger rapidly moves to the input surface 7a to touch the input surface and rapidly moves away therefrom, the capacitance between the electrodes may change in a short time, which may be detected by the pad detector 12.

As shown in FIG. 2, the input surface 7a of the input pad 7 may be divided into a plurality of regions in advance, and various operation functions may be allocated thereto. How to set the number of divided regions or the area of the region or how to allocate which function to each region may be set and changed by operating the setting menu of a pad driver software 24 to be described later.

FIG. 3 is a block diagram showing the input processing device 10 provided in the personal computer 1.

As described above, the planar input member 5 may include the driving circuit 11 which sequentially may apply a pulsar voltage to the X electrode and the Y electrode of the input pad 7, and the pad detector 12 which may detect a variation in the rising time of the voltage in the detection electrode provided in the input pad 7. The pad detector 12 may be capable of specifying the finger contact position on the input surface 7a as the coordinate position on the X-Y coordinate. In addition, the operation signals of the right button 8 and the left button 9 also may be detected by the pad detector 12.

A pad input signal generator 13 may be provided in the input member 5. In the pad input signal generator 13, the X-Y coordinate information as the operation signal of the input pad 7, the switch input information of the right button 8, and the switch input information of the left button 9 detected by the pad detector 12 may be considered as format data having a predetermined number of bytes, and may be output from an output interface 14. The operation signal output from the output interface 14 may be sent to an input interface 21 provided in a controller 20 of the personal computer. The output interface 14 and the input interface 21 may be USB interfaces and the like, for example. In addition, it may be desirable that the generated operation signal include rotation information to be described later in addition to the X-Y coordinate information or the switch input information.

In addition, in the case where the rotation information is not included in the operation signal, the pad driver software 24 may generate the rotation information from the operation signal (X-Y coordinate information) sent from the pad input signal generator 13.

The controller 20 of the personal computer 1 may store a variety of software. The controller 20 may store an operation system (OS) 22. A display driver 23 may be controlled by the operating system 22, and a variety of information may be displayed on the display 6.

The pad driver software 24 may be installed in the controller 20. The operation signal received by the input interface 21 may be sent to the pad driver software 24. In the pad driver software 24, a coordinate data signal and the like may be generated on the basis of a predetermined format of the operation signal sent from the pad input signal generator 13, and may be informed to the operating system 22.

Here, the X-Y coordinate information may be information representing the absolute position or the relative position on the input surface 7a of the input pad 7 with which the operator's finger comes into contact. In addition, the rotation information may be information which can be obtained when the finger moves on the input surface 7a in a predetermined direction, and may include, for example, a rotation direction (right rotation or left rotation), a rotation angle, a continuous rotation, and the like.

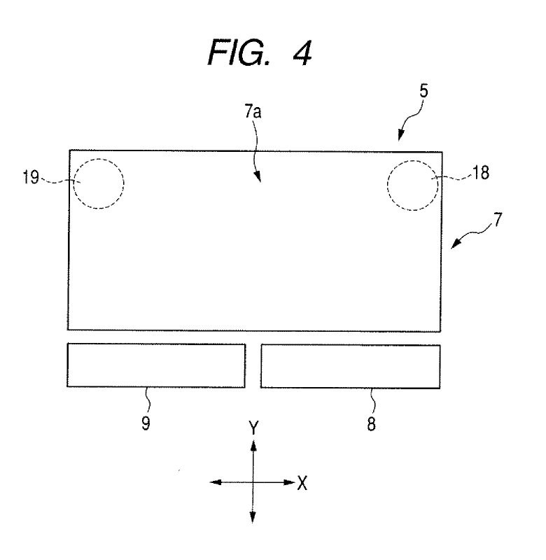

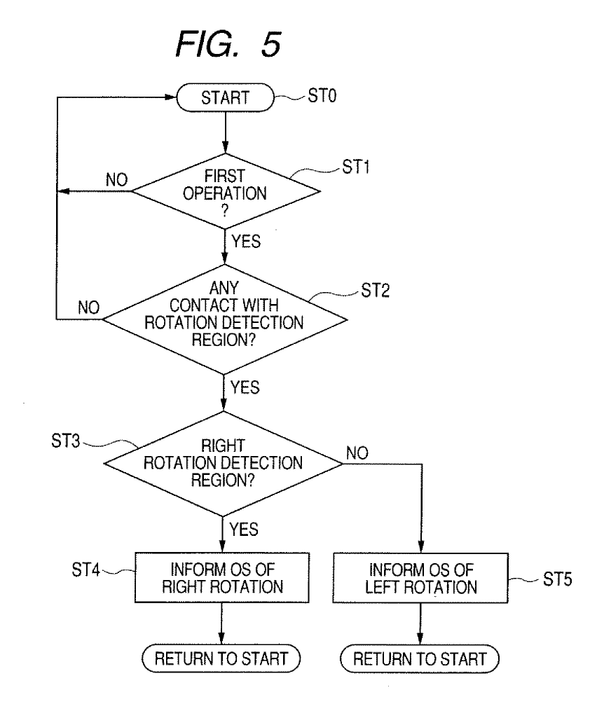

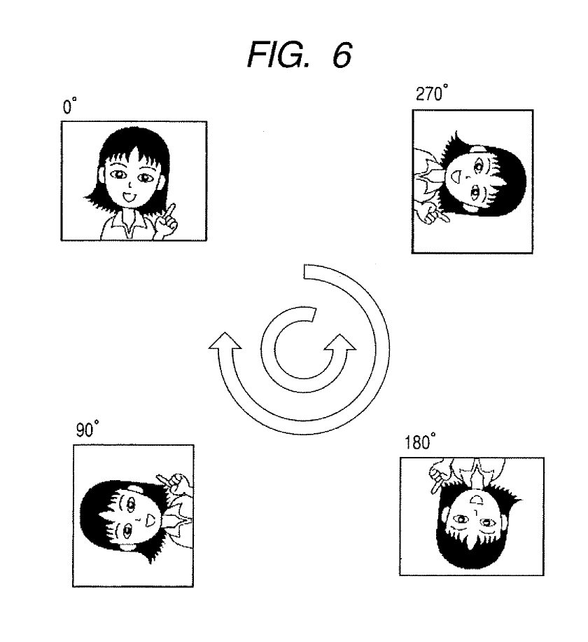

FIG. 4 is a plan view of the input pad showing an exemplary embodiment, and FIG. 5 is a flowchart showing an example of the operation process by the driver software according to this exemplary embodiment. FIG. 6 is a conceptual diagram showing an example of a rotating image.

In the exemplary embodiment shown in FIG. 4, a right rotation detection region 18 and a left rotation detection region 19 may be respectively allocated to the right upper corner and the left upper corner of the input pad 7 so as to have a circular shape. In addition, such allocation may be set and changed by operating the setting menu of the pad driver software 24. For example, when the input pad 7 and the like are operated by changing the setting menu, it may be possible to change the diameters of the right rotation detection region 18 and the left rotation detection region 19. In addition, it may be possible to move the centers of the right rotation detection region 18 and the left rotation detection region 19 to the Y direction or the X direction.

In the setting menu, the rotation angle θ for each operation, the repeating time t1 for performing the operation process, and the like may be set and changed in this manner. The rotation angle θ for each operation may be the unit of 90° as shown in FIG. 6, but may be, for example, the units of 1°, 5°, 15°, 30°, 45°, 60°, 120°, and the like. It may be desirable that the rotation angle is set and changed to an arbitrary rotation angle in accordance with the operator's desire.

In addition, each step of the operation process is described as “ST” in the following description.

As shown in FIG. 5, when the operation process of the pad driver software 24 starts (ST0), the process moves to ST1 so as to start the monitor of the output from the pad input signal generator 13. In addition, in ST1, it may be determined whether the operator's finger comes into contact with the input surface 7a of the input pad 7 as a first operation. In the case of YES, the process may move to ST2 so as to check whether the finger contact position is a predetermined rotation detection region.

In the case of NO, that is, the case where the operator's finger comes into contact with the input surface 7a, but the position is not in the right rotation detection region 18 or the left rotation detection region 19, the process may return to the start (ST0) so as to resume the monitor of the pad input signal generator 13. In the case of YES, that is, the case where the operator's finger comes into contact with the input surface 7a, and the position is in the right rotation detection region 18 or the left rotation detection region 19, the process may move to ST3.

In ST3, it may be determined whether the contact position is the right rotation detection region 18 or the left rotation detection region 19. In ST3, in the case of YES, that is, the case where the finger contact position is the right rotation detection region 18, the process may move to ST4. In the case of NO, that is, the case where the finger contact position is the left rotation detection region 19 instead of the right rotation detection region 18, the process may move to ST5.

In ST4, the pad driver software 24 may create the rotation information so that the rotation direction is set to the right rotation, the rotation angle is set to θ, and the like, and informs the rotation information of the operating system 22. Then, the process may return to the start (ST0). Likewise, in ST5, the rotation information may be created so that the rotation direction is set to the right rotation, the rotation angle is set to θ, and the like, the rotation information is informed to the operating system 22, and then the process may return to the start (ST0).

As shown in FIG. 6, the operating system 22 may rotate the image displayed on the display 6 on the basis of the obtained rotation information.

The operation process shown in FIG. 5 may be repeatedly performed at, for example, a predetermined repeating time t1. In this case, during a time when the operator's finger comes into contact with the right rotation detection region 18 or the left rotation detection region 19 (during a time when the push operation is continued), the rotation of the image may be sequentially repeated by the rotation angle θ so that the image may rotate in one direction. That is, in the case where the operator's finger comes into contact with the right rotation detection region 18, the image may continuously rotate in the right rotation direction. In the case where the operator's finger comes into contact with the left rotation detection region 19, the image may continuously rotate in the left rotation direction. In addition, when the operator's finger moves away from the right rotation detection region 18 or the left rotation detection region 19, the rotation may be stopped. Further, when the repeating time t1 is set to be comparatively long, it may be possible to intermittently rotate the image.

In the case where the operator's finger performs a tap operation, that is, the operator's finger comes into contact with the right rotation detection region 18 or the left rotation detection region 19 for a short time, the operation process shown in FIG. 5 may be performed only once. For this reason, in the case where the contact position is the right rotation detection region 18, it may be possible to rotate the image in the right rotation direction by the rotation angle θ. In the case where the contact position is the left rotation detection region 19, it may be possible to rotate the image in the left rotation direction by the rotation angle θ. Accordingly, when the operator repeatedly performs the tap operation, for example, it may be possible to intermittently rotate the image by the predetermined angle θ as shown in FIG. 6. Further, it may be possible to freely change the rotation direction of the image based on the tap operation or the push operation in accordance with the operator's operation on the right rotation detection region 18 or the left rotation detection region 19.

In addition, in the case where the operator's finger comes into contact with the input surface 7a only for a short time, the tap operation for performing the rotation may be determined. If a problem is caused by the rotation, the normal tap operation or the tap operation for the rotation may be determined on the basis of the time during which the finger comes into contact with the input surface 7a. That is, for example, in the case where the contact time is shorter than a first predetermined threshold time, the normal tap operation may be determined. In the case where the contact time is longer than the first predetermined threshold time and is shorter than the second predetermined threshold time, the tap operation for the rotation of the image may be determined. In the case where the contact time is much longer than the second predetermined threshold time, the push operation may be determined. In this manner, it may be possible to determine the operations. In addition, in the case where the normal tap operation is determined, the pad driver software 24 may create information representing the normal tap operation, and may inform the operating system 22 of the information. On the other hand, in the case where the tap operation for rotating the image is determined, the pad driver software 24 may create the rotation information such that the rotation direction may be set to the right rotation (or the left rotation), the rotation angle may be set to θ, the continuous rotation may not be set, and the like. In the case where the push operation is determined, the pad driver software 24 may create the rotation information such that the rotation direction may be set to the right rotation (or the left rotation), the rotation angle may be set to θ, the continuous rotation may be set. The rotation information may be informed to the operating system 22.

Likewise, in an exemplary embodiment, it may be possible to rotate the image by an arbitrary rotation angle or to continuously rotate the image in a desired direction by performing a simple operation such as the tap operation or the push operation on the right rotation detection region 18 or the left rotation detection region 19. Further, since it may be possible to perform the tap operation and the push operation by using one finger, it may be possible to improve the operability.

In such an embodiment, a case has been described in which the rotation operation may be performed in the corners of two positions of the right rotation detection region 18 and the left rotation detection region 19, but the invention is not limited thereto. For example, the rotation detection region may be provided in one corner of one position of the input surface 7a, or the corners of three positions. In the case where the rotation detection region is the corner of one position, it may be possible to perform the operation at that position without moving the finger, and thus to further improve the operability.

However, in the case where the rotation detection region is in the corner of one position, the rotation direction may be limited to one direction. However, it may be possible to change the rotation direction by changing the setting of the setting menu of the pad driver software 24.

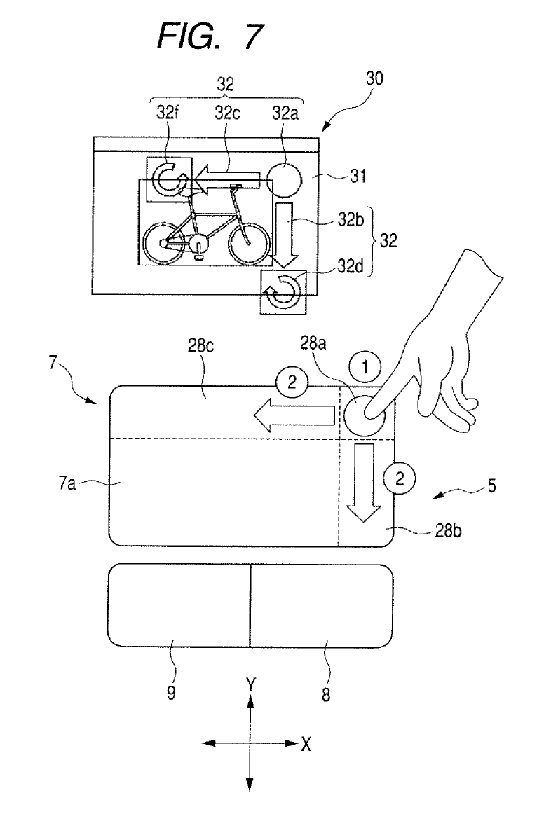

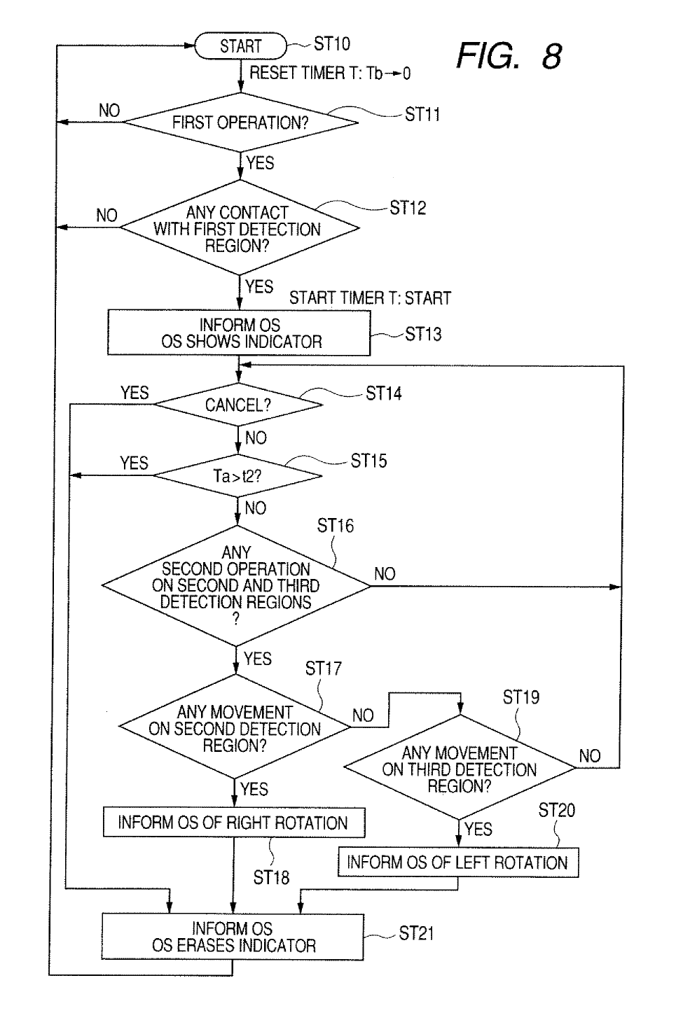

FIG. 7 is a plan view of the input pad showing an exemplary embodiment of the invention, and a diagram showing an example of the indicator displayed on the display. FIG. 8 is a flowchart showing an example of the operation process by the driver software according to this embodiment.

In the embodiment shown in FIG. 7, it may be possible to allocate a first detection region 28a to a right upper corner of the input surface 7a of the input pad 7. In addition, it may be possible to allocate a second belt-like detection region 28b which may extend in the Y direction from the lower portion of the first detection region 28a, and a third belt-like detection region 28c which may extend in the X direction from the left portion of the first detection region 28a. Further, the position of the first detection region 28a may not be limited to the right upper corner if there are several corners in the input surface 7a.

As shown in FIG. 8, when the operation process of the pad driver software 24 starts (ST10), the timer T may be reset (Tb→0), and the process may move to ST11 so as to start the monitor of the output from the pad input signal generator 13. Then, in ST11, in the case of YES, that is, the case where the first operation of allowing the operator's finger to come into contact with the input surface 7a of the input pad 7 is detected, the process may move to ST12 so as to check whether the finger contact position is the first detection region 28a. In ST12, in the case of YES, that is, the case where the finger contact position is the first detection region 28a, the process may move to ST13. In the case of NO, that is, the case where the finger contact position is other than the first detection region 28a, the process may return to the start (ST10). In addition, the first operation may be, for example, the tap operation and the like.

In ST13, the pad driver software 24 may inform the operating system 22 that the first operation is performed on the first detection region 28a. When the operating system 22 receives the information, for example, the operating system 22 may display an indicator (guide screen) 30 on the display 6 as shown in FIG. 7. In addition, at this time, the elapsed time Tb may be measured by the timer T.

The indicator 30 may include a background image 31 and a guide image 32 which may show the contents to be operated at the next time. It may be desirable that the background image 31 indicates the image (the drawing of a bicycle in FIG. 7) currently displayed on the display 6 as a depicted image. However, the background image 31 may be a predetermined image (default image) or a solid-color image. Also, the background image 31 may be a transparent or translucent object. In addition, it may be desirable that the background image is set or changed by the operator.

In the embodiment, for example, as shown in FIG. 7, the guide image 32 may include five figures or signs, that is, for example, a circle 32a, a downward arrow 32b, a leftward arrow 32c, a clockwise rotation arrow 32d may be provided in the tip end of the downward arrow, and a counter-clockwise rotation arrow 32f may be provided in the tip end of the leftward arrow.

The circle 32a may correspond to the position of the first detection region 28a on the input surface 7a, and the downward arrow 32b and the leftward arrow 32c may indicate the operation directions from the circle 32a. In addition, the clockwise rotation arrow 32d may indicate that the image rotates in the right rotation direction when the finger moves from the circle 32a along the downward arrow 32b, and the counter-clockwise rotation 32f may indicate that the image rotates in the left rotation direction when the finger moves from the circle 32a along the leftward arrow 32c.

In addition, it may be desirable that the operator freely sets or changes whether the indicator 30 is displayed or not.

In ST14, it may be monitored whether the display of the indicator 30 is canceled by the operator. In the case of NO, that is, the case where the display is not canceled, the process may move to ST15. In the case of YES, that is, the case where the display is canceled, the display of the indicator 30 is erased (ST21), and the process may return to the start (ST10).

In ST15, it may be monitored whether the elapsed time Tb after starting the measurement of the timer T exceeds a predetermined specified time t2. In the case of YES, that the case where the elapsed time exceeds the predetermined time, the display of the indicator 30 may be erased (ST21), and the process may return to the start (ST0). In the case of NO, that is, the case where the elapsed time Tb of the timer T does not exceed the predetermined specified time t2, the process after ST16 may be performed so as to specify the detection region.

In ST16, it may be checked whether a second operation is performed by the operator's finger in the second detection region 28b or the third detection region 28c within the predetermined specified time t2. In ST16, in the case of YES, that is, the case where the second operation is performed in the second detection region 28b or the third detection region 28c, the process after ST17 may be performed so as to check whether the finger moves. In addition, in the case where the second operation by the operator's finger is detected in a region other than the second detection region 28b or the third detection region 28c (the case of NO in ST16), the process before ST14 may be performed. Further, here, the second operation may be a slide operation in which the operator's finger slides on the second detection region 28b or the third detection region 28c.

In ST17, when it is detected that the operator's finger moves on the second detection region 28b, the process may move to ST18. In ST18, in the case of YES, that is, the case where the second operation is performed in the second detection region 28b, the pad driver software 24 may determine that there is an operation of prompting the right rotation. The pad driver software 24 may create the rotation information such that the rotation direction may be set to the right rotation, the rotation angle may be set to θ, and the like, and may inform the operating system 22 of the rotation information.

On the other hand, in the case of NO, that is, the case where the movement of the finger is not detected in the second detection region 28b, the process may move to ST19 so as to detect the movement of the finger in the third detection region 28c. In ST19, in the case of YES, that is, the case where the operator's finger moves on the third detection region 28c, the process may move to ST20. In ST20, in the case where the second operation is performed in the third detection region 28c, the pad driver software 24 may determine that there is an operation of prompting the left rotation. The pad driver software 24 may create the rotation information such that the rotation direction may be set to the left rotation, the rotation angle may be set to θ, and the like, and may inform the operating system 22 of the rotation information.

Then, when the operating system 22 receives the rotation information in ST18 or ST20, the operating system 22 may rotate the image displayed on the display 6 on the basis of the obtained rotation information. In addition, the operating system 22 may erase the display of the indicator 30 (ST21) at the same time when the image rotates or immediately before the image rotates.

In addition, the second operation in this case is not limited to the slide operation, but may also be a push operation in which the operator's finger continuously comes into contact with the second detection region 28b or the third detection region 28c for a predetermined elapsed time or more. The push operation may be specified as an operation of prompting the continuous rotation. In ST18 or ST20, the rotation information having the continuous rotation added thereto may be created, and may be informed to the operating system 22. Accordingly, it may be possible to continuously rotate the image in the right rotation direction or the left rotation direction during a time when at least the operator's finger comes into contact with the second detection region 28b or the third detection region 28c.

Likewise, in such an embodiment, it may be possible to rotate the image through the indicator 30 by performing the operation along the indicator 30. For this reason, it may be possible for even a clumsy operator to reliably rotate the image. In addition, since it may be possible to perform the operation by using one finger even in this embodiment, it may be possible to improve the operability.

In addition, the image may be rotated by a predetermined rotation angle θ whenever the operator's finger repeatedly moves on the second detection region 28b or the third detection region 28c, or the rotation angle may be adjusted in proportion to the movement amount of the finger or the contact time. In the former case in which the image is rotated whenever the finger moves on the second detection region 28b or the third detection region 28c, it may be supposed that the smooth rotation operation is disturbed by the indicator 30 displayed every time. In this case, it may be possible to handle the problem in such a manner that the indicator 30 is set so as not to be displayed by operating the setting menu of the pad driver soft 24. In addition, in the latter case in which the image is rotated in proportion to the movement amount of the finger or the contact time, it may be possible to promptly rotate the image in accordance with the operator's desire.

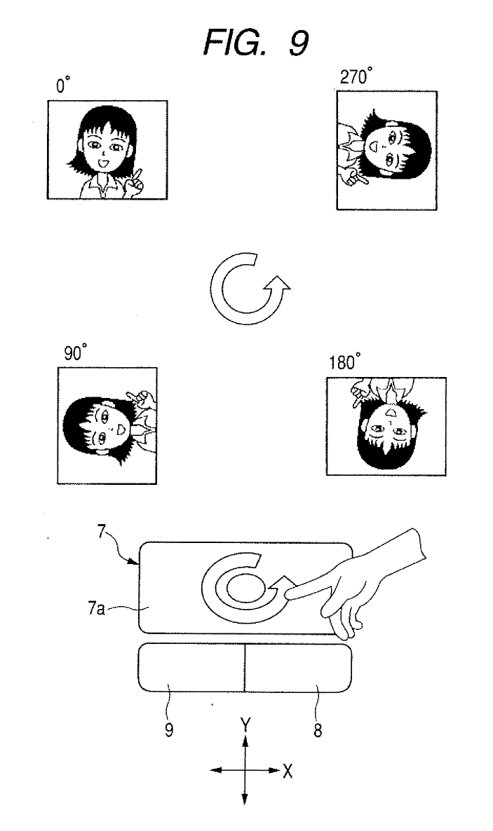

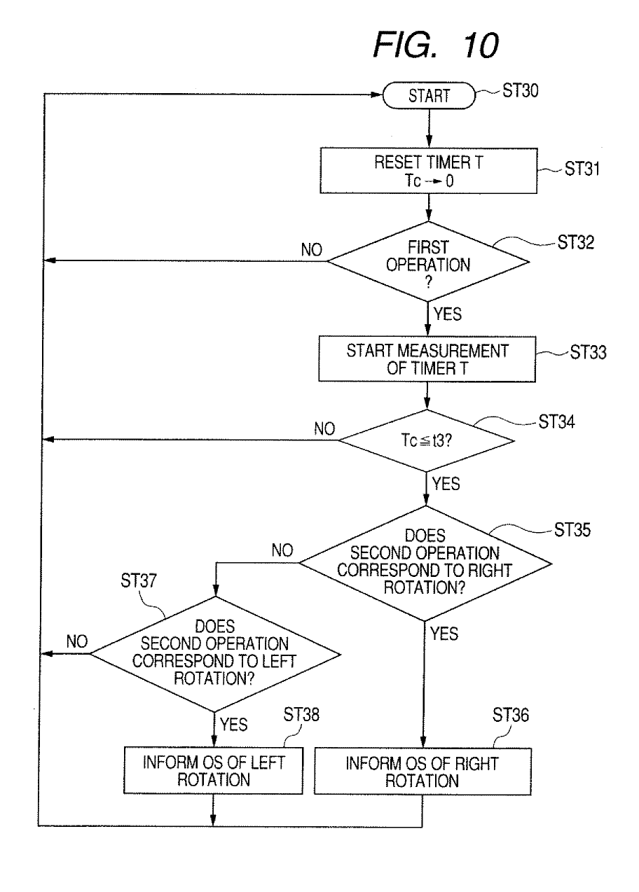

FIG. 9 is a plan view of the input pad showing an exemplary embodiment, and a diagram showing a relationship with the rotating image. FIG. 10 is a flowchart showing an example of the operation process by the driver software according to this embodiment.

In the exemplary embodiment shown in FIG. 9, a specific detection region may not be allocated onto the input surface 7a of the input pad 7, but the entire region of the input surface 7a may serve as the detection region.

As shown in FIG. 10, when the operation process starts (ST30), the pad driver software 24 may move to ST31 and may reset the timer T (Tc→0).

Subsequently, the pad driver software 24 may start a normal monitor of the output from the pad input signal generator 13. Subsequently, in ST32, in the case of YES, that is, the case where the first operation is performed by the operator's finger in the input surface 7a of the input pad 7, the process may move to ST33. In the case where the first operation is not detected, the process returns to the start (ST30). In addition, here, the first operation may be, for example, a tap operation.

In ST33, the measurement using the timer T may start. In addition, the pad driver software 24 may check whether the rotation operation is performed on the input surface 7a as the second operation within the predetermined specified time t3 after the first operation (tap operation) after ST33. In addition, in this case, it may be desirable that the second operation is performed to have a circular locus about, for example, the position of the first operation. The locus may not be an accurate circle, but may be a substantially circular shape. In addition, the circular locus of the second operation may not be formed about the position of the first operation, but may include the center point of the first operation on the inside of the circular locus.

In ST34, the elapsed time Tc of the timer T may be checked. In the case of YES, that is, the case where the elapsed tame Tc of the timer T is within the predetermined specified time t3, the process may move to ST35. In the case of NO, that is, the case where the elapsed time Tc exceeds the predetermined specified time t3, the process may return to the start (ST30).

In ST35, it may be checked whether the second operation performed on the input surface 7a within the predetermined specified time t3 is the right rotation. In the case of YES, that is, the right rotation, the process may move to ST36. In ST36, the pad driver software 24 may create the rotation information such that the rotation direction may be set to the right rotation, the rotation angle may be set to θ, and the like, and may inform the operating system 22 of the rotation information.

On the other hand, in the case of NO, that is, the case where the second operation is not the right rotation as a result of the check in ST35, the process may move to ST37 so as to check whether the left rotation is performed. In the case of YES, that is, the left rotation, the process may move to ST38. In the case of NO, that is, the case where the left rotation is not performed, it may be determined that an operation other than the rotation operation is performed, and the process returns to the start (ST30).

In ST38, the pad driver software 24 may create the rotation information such that the rotation direction may be set to the left rotation, and the rotation angle may be set to θ, and the like, and may inform the operating system 22 of the rotation information.

Then, when the operating system 22 receives the rotation information in ST36 or ST38, for example, as shown in FIG. 9, the operating system 22 may rotate the image displayed on the display 6 on the basis of the obtained rotation information.

In addition, in such an embodiment, the first operation may be the tap operation. However, in the case where it is necessary to distinguish the normal tap operation from the tap operation for the rotation operation, the push operation having the finger contact time with respect to the input surface 7a may be longer than that of the normal tap operation may be set as the first operation. In this case, it may be possible to distinguish the tap operation from the push operation on the basis of whether the finger contact time with respect to the input surface 7a exceeds a threshold time. Also, the push operation may be determined in the case where the finger contact area with respect to the input surface 7a exceeds a threshold area.

Likewise, in this embodiment, it may be possible to rotate the image displayed on the display 6 by a desired rotation angle or to continuously rotate the image through a simple operation in which the rotation operation as the second operation is performed after the first operation. Further, since it may be possible to continuously perform the first operation and the second operation by using one finger, it may be possible to improve the operability.

Further, since the first operation and the second operation need to be performed through two stages of operations, it may be possible to prevent such a problem that the image is arbitrarily rotated on the contrary to the operator's intension when the finger carelessly comes into contact with the input surface 7a. Further, since the first operation may be used as a previous operation upon starting the rotation operation, it may be possible to smoothly perform the subsequent rotation operation.

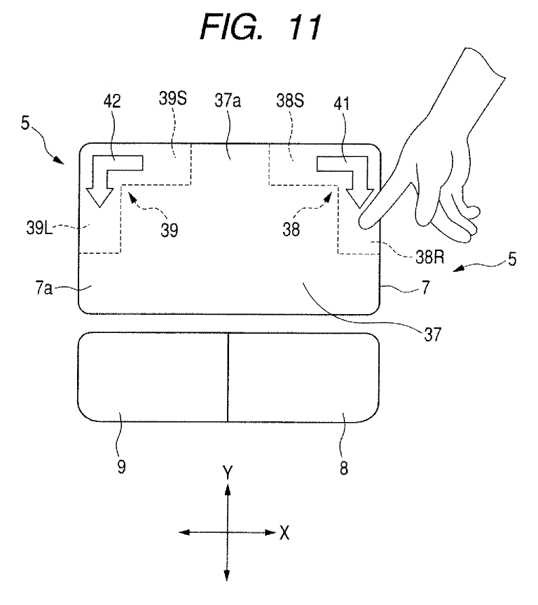

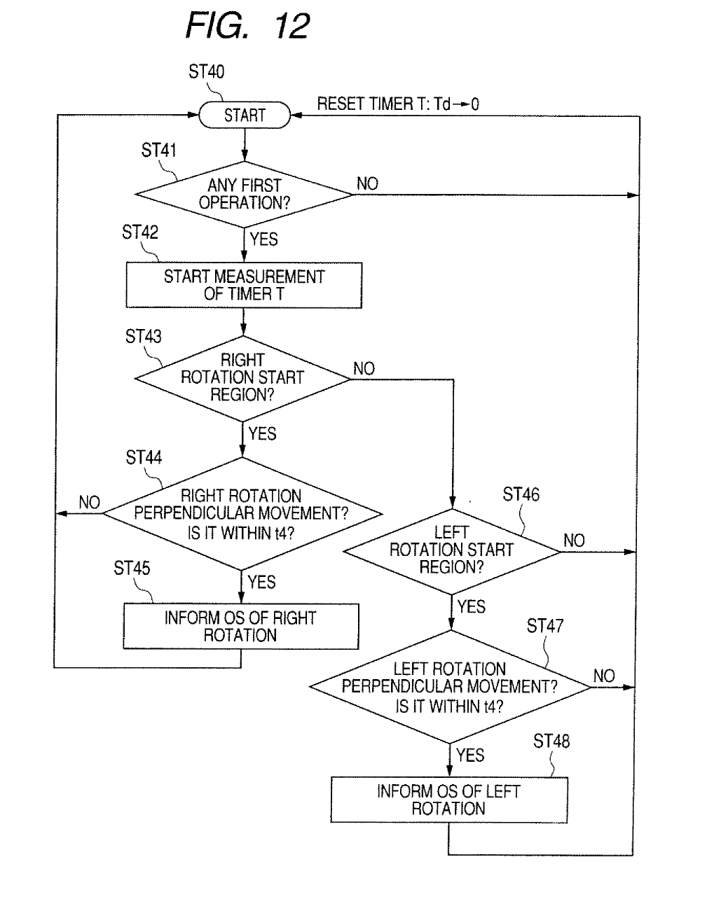

FIG. 11 is a plan view of the input pad showing an exemplary embodiment, and FIG. 12 is a flowchart showing an example of the operation process by the driver soft according to this embodiment.

In the example shown in FIG. 11, an operation region 37 having a wide area may be set in the center portion of the input surface 7a of the input pad 7, and a right operation region 38 may be provided in the vicinity of the right upper corner. The right operation region 38 may include a right end rotation region 38R which may extend in the lengthwise direction (Y direction) from the right upper corner so as to have a belt shape, and a right rotation start region 38S which may extend in the transverse direction (X direction) from the right upper corner so as to have a belt shape, where the right end rotation region 38R and the right rotation start region 38S may intersect each other at the right upper corner.

Likewise, a left operation region 39 including a left end rotation region 39L and a left rotation start region 39S may be set in the vicinity of the left upper corner of the operation region 37, where the left end rotation region 39L and the left rotation start region 39S intersect each other. In addition, the right rotation start region 38S of the right upper end may be separated from the left rotation start region 39S of the left upper end by a convex operation region 37a provided therebetween. Further, an arrow 41 of FIG. 11 may indicate an operation of prompting the right rotation, and an arrow 42 may indicate an operation of prompting the left rotation. The arrows 41 and 42 may be printed on the input surface 7a.

As shown in FIG. 12, in such an embodiment, when the operation process starts (ST40), first, the timer T may be reset (Td→0).

Subsequently, the pad driver software 24 may move to ST41, and may start the monitor of the output from the pad input signal generator 13. Then, in ST41, it may be checked whether the operator's finger comes into contact with the right operation region 38 or the left operation region 39 on the input surface 7a as the first operation. In the case of YES, that is, the case where the first operation is detected, the process may move to ST42. In the case of NO, that is, the case where the first operation is not detected, the process may return to the start ST40. The first operation may include slide operation or push operation.

In ST42, the measurement of the elapsed time Td may start by operating the timer T.

In ST43 and ST46, the position of the first operation may be specified. In ST43, it may be checked whether the finger contact position is the right rotation start region 38S. In the case of YES, that is, the case where the finger contact position is the right rotation start region 388, the process may move to ST44. In the case of NO, that is, the case where the finger contact position is not the right rotation start region 38S, the process may move to ST46. In ST46, it may be checked whether the finger contact position is the left rotation start region 39S. In the case of YES, that is, the case where the finger contact position is the left rotation start region 39S, the process may move to ST47. In the case of NO, that is, the case where the finger contact position is not the left rotation start region 39S, it may be determined that the position other than the right rotation start region 38S and the left rotation start region 39S is operated, and the process may return to the start ST40.

In ST44, it may be checked whether the second operation is performed. That is, in ST44, it may be checked whether the right rotation perpendicular movement operation (an operation is performed along the arrow 41, and the finger moves rightward on the right rotation start region 38S so as to further move downward on the right end rotation region 38R by changing a direction at the right upper corner in the perpendicular direction) of the finger is performed as the second operation. In the case of YES, that is, the case where the right rotation perpendicular movement operation is detected within a predetermined specified time t4 (the elapsed time Td is within the predetermined specified time t4), the process may move to ST45. In the case of NO, that is, the case where the right rotation perpendicular movement operation is not detected within the predetermined specified time t4, the process may return to the start ST40.

In ST45, in the case of YES, that is, the case where the first operation is first detected in the right rotation start region 385, and the right rotation perpendicular movement operation is detected as the second operation within the predetermined specified time t4, it may be determined that the operation (which means the right rotation operation) indicated by the arrow 41 of FIG. 11 is performed. The pad driver software 24 may create the rotation information such that the rotation direction maybe set to the right rotation, the rotation angle may be set to θ, and the like. The pad driver software 24 may inform the operating system 22 of the rotation information, and the process may return to the start (ST0).

Likewise, in ST47, it may be checked whether the left rotation perpendicular movement operation (the operation is along the arrow 42, and the finger moves leftward on the left rotation start region 39S so as to further move downward on the left end rotation region 39L by changing a direction at the left upper corner in the perpendicular direction) is performed as the second operation. In the case of YES, that is, the case where the left rotation perpendicular movement operation is detected within the predetermined specified time t4 (the elapsed time Td is within the predetermined specified time t4), the process may move to ST48. In the case of NO, that is, the case where the left rotation perpendicular movement operation is not detected within the predetermined specified time t4, the process may return to the start ST40.

In ST48, in the case where the first operation is first detected in the left rotation start region 39S, and the left rotation perpendicular movement operation is detected as the second operation within the predetermined specified time t4, it may be determined that the operation (which means the left rotation operation) indicated by the arrow 42 of FIG. 11 is performed. The pad driver software 24 may create the rotation information such that the rotation direction may be set to the left rotation, the rotation angle may be set to θ, and the like. The pad driver software 24 may informs the operating system 22 of the rotation information, and the process may return to the start (ST0).

Subsequently, when the operating system 22 receives the rotation information from ST45 or ST48, the operating system 22 may rotate the image displayed on the display 6 on the basis of the rotation information.

Likewise, it may be possible to rotate the image displayed on the display 6 through a simple operation in which the finger moves to the vicinity of the right upper corner of the input surface 7a or the left upper corner thereof at right angle. In addition, since it may be possible to continuously perform the first operation and the second operation by using one finger, it may be possible to improve the operability.

In addition, since the first operation and the second operation need to be performed through two stages of operations, the image may not be arbitrarily rotated just by an operation in which the finger carelessly comes into contact with the input surface 7a. Further, since the first operation may be used as a previous operation waiting for the input of the second operation, it may be possible to smoothly perform the subsequent second operation.

It should be understood by those skilled in the art that various modifications, combinations, sub-combinations and alterations may occur depending on design requirements and other factors insofar as they are within the scope of the appended claims of the equivalents thereof.

Accordingly, the embodiments of the present inventions are not to be limited in scope by the specific embodiments described herein. Further, although some of the embodiments of the present invention have been described herein in the context of a particular implementation in a particular environment for a particular purpose, those of ordinary skill in the art should recognize that its usefulness is not limited thereto and that the embodiments of the present inventions can be beneficially implemented in any number of environments for any number of purposes. Accordingly, the claims set forth below should be construed in view of the full breadth and spirit of the embodiments of the present inventions as disclosed herein. While the foregoing description includes many details and specificities, it is to be understood that these have been included for purposes of explanation only, and are not to be interpreted as limitations of the invention. Many modifications to the embodiments described above can be made without departing from the spirit and scope of the invention.

What is claimed is:

1. An input processing device comprising:
an input pad having an input surface provided with a detection region for detecting a specific input operation;
a detector which detects a position of an indicating object coming into contact with the input pad; and
a processor which controls a display state of an image displayed on a display on the basis of an input signal obtained from the detector,
wherein when the processor receives the input signal corresponding to the specific input operation given from the indicating object onto the detection region, the processor rotates the image.

2. The input processing device according to claim 1,
wherein when the specific input operation is a tap operation, the image is rotated upon detecting performance of the tap operation.

3. The input processing device according to claim 1,
wherein when the specific input operation is a push operation having a contact time longer than that of a tap operation, the image is continuously rotated during the push operation.

4. The input processing device according to claim 1,
wherein the detection region is allocated to any position of the input surface.

5. The input processing device according to claim 1,
wherein the detection region is provided at two corners of the input surface so that the image is rotated right when the corner at one position is operated, and the image is rotated left when the corner at the other position is operated.

6. The input processing device according to claim 1,
wherein the specific input operation includes a first operation and a second operation performed after the first operation.

7. The input processing device according to claim 6,
wherein the first operation is detected in a first detection region, and the second operation is detected in a detection region different from the first detection region.

8. The input processing device according to claim 6,
wherein when the first operation is performed, an indicator showing instructions of the second operation is displayed.

9. The input processing device according to claim 6,
wherein a detection region for detecting the second operation includes second and third detection regions extending in directions intersecting each other so that the image is rotated right when the second operation is performed on the second detection region, and the image is rotated left when the second operation is performed on the third detection region.

10. The input processing device according to claim 6,
wherein the second operation is a rotation operation drawn in a circular shape by the indicating object around the first operation.

11. The input processing device according to claim 6,
wherein the first operation is a tap operation, and the second operation is a slide operation or a push operation.

12. The input processing device according to claim 1,
wherein the specific input operation is a rotation perpendicular movement operation of moving the indicating object in the perpendicular direction in the vicinity of the corner of the input surface.

13. The input processing device according to claim 1,
wherein the processor is operated by a software stored in a controller of a personal computer.

14. The input processing device according to claim 13,
wherein the processor is operated by a driver software for giving coordinate information to an operating system inside a controller on the basis of the input signal from the detector.

15. The input processing device according to claim 14,
wherein the driver software is able to change a setting of a rotation angle of the image.
